(19) United States
(12) Patent Application Publication
(10) Pub. No.: US 2020/0095128 A1
(43) Pub. Date: Mar. 26, 2020

(54) Flexible graphene film and preparation method thereof

(71) Applicant: Hangzhou Gaoxi Technology Co., Ltd., Hangzhou, Zhejiang (CN)

(72) Inventors: Chao Gao, Hangzhou, Zhejiang (CN); Zhen Xu, Hangzhou, Zhejiang (CN); Youhua Xiao, Hangzhou, Zhejiang (CN)

(21) Appl. No.: 16/469,145

(22) PCT Filed: Feb. 26, 2018
(86) PCT No.: PCT/CN2018/077171

§ 371 Date: Jun. 13, 2019

(30) Foreign Application Priority Data
Apr. 11, 2017 (CN) 201710232564.1
Apr. 11, 2017 (CN) 201710232708.3

(51) Int. Cl. C01B 32/198; C01B 32/184

(52) U.S. Cl. CPC C01B 32/198; C01B 32/184

(57) ABSTRACT

The present invention discloses a flexible graphene film and a preparation method thereof. The preparation method includes steps of placing a liquid graphene oxide film in a poor solvent, performing gelation, and drying a graphene oxide gel film. The graphene film has an excellent flexibility, a crystallinity of lower than 60% and an elongation at break of 15-50%, wherein no crease is remained after the flexible graphene film is repeatedly folded more than 100,000 times. The preparation method of the graphene film provided by the present invention controls the macroscopic properties of the graphene film by microscopically controlling the morphology of the graphene monolith, and can significantly improve the flexibility of the graphene film. It can significantly improve the flexibility of the graphene film. The process is simple and easy to be popularized, and has potential applications in flexible electronic devices and the like.

### CROSS REFERENCE OF RELATED APPLICATION

This is a U.S. National Stage under 35 U.S.C. 371 of the International Application PCT/CN2018/077171, filed Feb. 26, 2018, which claims priority under 35 U.S.C. 119(a-d) to CN 201710232564.1, filed Apr. 11, 2017, and CN 201710232708.3, filed Apr. 11, 2017.

### BACKGROUND OF THE PRESENT INVENTION

### Field of Invention

The present invention relates to the field of nanomaterial preparation, and particularly to a method for preparing a flexible graphene film.

### Description of Related Arts

In 2010, Andre GeiM and Konstantin Novoselov won the Nobel Prize in Physics for their first demonstration of the existence of two-dimensional graphene and its excellent properties.

Graphene is a two-dimensional single-atom layer honeycomb periodic lattice structural crystal composed of carbon atoms in a form of sp² hybrid orbits. It has an excellent electrical property (for example, its electron mobility at room temperature is up to 2×10⁵ cm²/Vs), an outstanding thermal conductivity of 5000 W/MK, an extraordinary specific surface area of 2630 M²/g, a Young's modulus of 1100 GPa and a breaking strength of 125 GPa. The electrical and thermal conductivity of graphene is better than that of metals. At the same time, graphene has advantages of high temperature and corrosion resistance, and it has the potential to replace metals in the field of electrothermal materials due to good mechanical properties and low density.

The graphene film is a macroscopic application form of graphene. However, macroscopic folds of most of the current flexible graphene films are based on the shrinkage of the stretched polymer substrate, or the corresponding graphene film is prepared based on the surface structure of the substrate, which means that the macroscopic graphene film is unable to be obtained by controlling the state of the graphene monolith and the fluctuations are not spontaneously generated.

### SUMMARY OF THE PRESENT INVENTION

Aiming at deficiencies of the prior art, an object of the present invention is to provide a flexible graphene film and a preparation method thereof.

The object of the present invention is achieved by technical solutions as follows. A flexible graphene film comprises multiple folded graphene oxide sheets which are lapped with each other, or comprises multiple folded graphene sheets which are lapped with each other, wherein a crystallinity of the flexible graphene film is lower than 60%.

A preparation method of a flexible graphene oxide film comprises steps of:

(S1) dispersing graphene oxide in a good solvent, obtaining a graphene oxide solution with a concentration in a range of 5-20 mg/mL, performing scraping-film, and obtaining a liquid graphene oxide film;

(S2) immersing the liquid graphene oxide film in a poor solvent for 2 to 24 h, performing gelation, and obtaining a graphene oxide gel film; and

(S3) drying the graphene oxide gel film, and obtaining the flexible graphene oxide film.

A preparation method of a flexible graphene film comprises steps of:

(S1) dispersing graphene oxide in a good solvent, obtaining a graphene oxide solution with a concentration in a range of 5-40 mg/mL, performing scraping-film, and obtaining a liquid graphene oxide film;

(S2) immersing the liquid graphene oxide film in a poor solvent for 1 to 24 h, performing gelation, and obtaining a graphene oxide gel film;

(S3) drying the graphene oxide gel film, and obtaining a flexible graphene oxide film; and

(S4) performing reduction on the flexible graphene oxide film, and obtaining the flexible graphene film.

Preferably, in the step of (S1), the good solvent is at least one member selected from a group consisting of N,N-dimethylformamide, water, N-methylpyrrolidone, acetone, dimethyl sulfoxide, pyridine, dioxane, N,N-dimethylacetamide, tetrahydrofuran and ethylene glycol.

Preferably, a thickness of the liquid graphene oxide film is in a range of 0.5 to 30 mm, and the scraping-film is performed at a speed in a range of 1 to 20 mm/s.

Preferably, in the step of (S2), the poor solvent is at least one member selected from a group consisting of ethyl acetate, dichloromethane, alkanes, methanol, ethanol, n-butanol, ethylene glycol, propylene glycol, glycerol, isobutanol, methyl acetate, butyl acetate, and acetic acid.

Preferably, in the step of (S3), the graphene oxide gel film is dried at 50-100° C. in an oven or is dried by hanging for 5-24 h.

Preferably, in the step of (S4), the reduction is chemical reduction, thermal reduction, or electroreduction.

Beneficial effects of the present invention are as follows. The present invention utilizes the interaction of the good solvent and the poor solvent to construct the graphene film with microscopic and macroscopic multi-stage folds which has excellent flexibility and the resistance to certain stretching and bending. It is tested that the graphene film has a crystallinity of less than 60% or even less than 30%; the graphene film has excellent flexibility, the elongation at break of the graphene oxide film is in a range of 20 to 50%, the elongation at break of the graphene film after reduction is in a range of 15 to 50%, and the conductivity of the graphene film after reduction is in a range of 10000 to 80000 s/m. The flexible graphene film provided by the present invention has great application in the field of flexible electronic devices and the like.

### BRIEF DESCRIPTION OF THE DRAWINGS

FIG. 1 is an analogic map of a crystalline graphene oxide film, an amorphous graphene oxide film, crystalline polymer and amorphous polymer.

FIG. 2 is an XRD diffraction comparison chart of a flexible graphene oxide film and a crystalline graphene oxide film.

FIG. 3 is a mechanical tensile curve of the flexible graphene oxide film.

FIG. 4A is a surface scanning electron micrograph of a graphene film; FIG. 4B is a sectional scanning electron micrograph of the graphene film.

FIG. 5 is an XRD diffraction comparison chart of a flexible graphene film and a crystalline graphene film.

FIG. 6A is a mechanical tensile curve of the flexible film and FIG. 6B is a resistance change graph of the flexible film being bent.

### DETAILED DESCRIPTION OF THE PREFERRED EMBODIMENT

In the present invention, a liquid GO film comprising monolithic graphene oxide with high concentration is placed in a poor solvent for being immersed, a good solvent of the liquid GO film is replaced by the poor solvent, causing that the graphene oxide sheets are shrunk and collapsed, so that the GO sheets are folded and lapped with each other to form a cross-linked network similar to cross-linked polymer, thereby constructing an amorphous GO film, as shown in FIG. 1. Further, during the drying process, the poor solvent is volatilized, and under the action of the capillary, the GO film is refolded macroscopically. These microscopic and macroscopic multi-stage folds give the graphene film excellent flexibility and resistance to certain stretching and bending. After testing, the crystallinity of the graphene film is less than 60%, even less than 30%, and the elongation at break of the graphene film is in a range of 20 to 50%, and further, a super-flexible graphene film is obtained by reduction.

The present invention will be further described with reference to accompanying drawings and embodiments. These embodiments are only used to further illustrate the present invention, and are not to be construed as limiting the protective scope of the present invention. Those skilled in the art will make some non-essential changes and adjustments according to the content of the above invention, which are all within the protective scope of the present invention.

### First Embodiment

(S1) Perform scraping-film on a graphene oxide solution DMF (N,N-dimethylformamide) with a concentration of 5 mg/mL by a scraper, and obtain a liquid graphene oxide film with a thickness of 30 mm;

(S2) Immerse the liquid graphene oxide film obtained by (S1) in a poor solvent ethyl acetate for 6 h, and obtain a self-supporting graphene oxide gel film; and

(S3) Dry the graphene oxide gel film obtained by (S2) through hanging in an oven at 70° C. for 10 h, and obtain a flexible graphene oxide film.

Contrast: the liquid graphene oxide film obtained by (S1) is directly dried at 70° C. for 10 h to obtain a crystalline graphene oxide film.

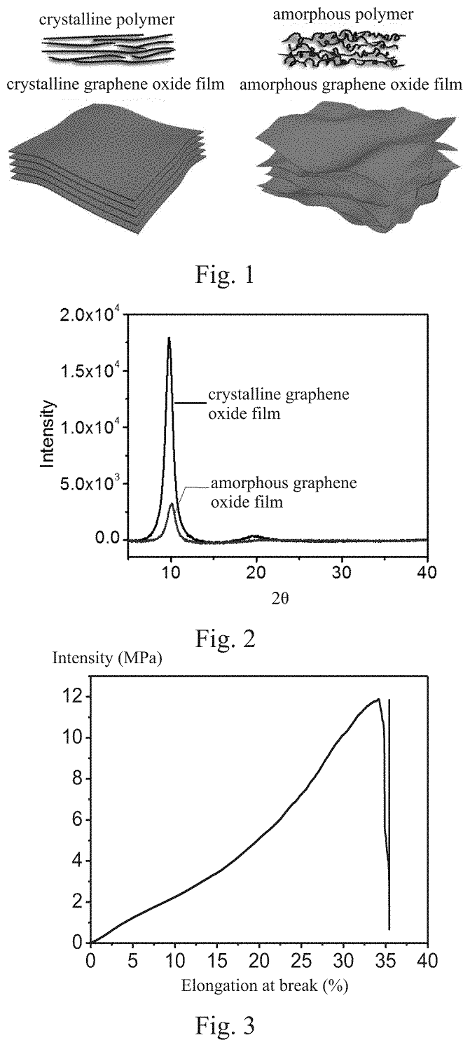

FIG. 2 shows an XRD diffraction comparison chart which is obvious that the graphene oxide film immersed by the poor solvent has lower crystallinity. The shrinkage folds of the graphene oxide sheets in the poor solvent and the shrinkage caused by the evaporation of the solvent in the process of drying the gel film both cause the macroscopic shrinkage of the graphene oxide film. The regularly stacked graphene oxide film which is not immersed by the poor solvent has a high crystallization peak, which is similar to the crystalline polymer.

### Second Embodiment

(S1) Perform scraping-film on a graphene oxide solution DMF with a concentration of 10 mg/mL by a scraper, and obtain a liquid graphene oxide film with a thickness of 1 mm;

(S2) Immerse the liquid graphene oxide film obtained by (S1) in a poor solvent ethyl acetate for 24 h, and obtain a self-supporting graphene oxide gel film; and

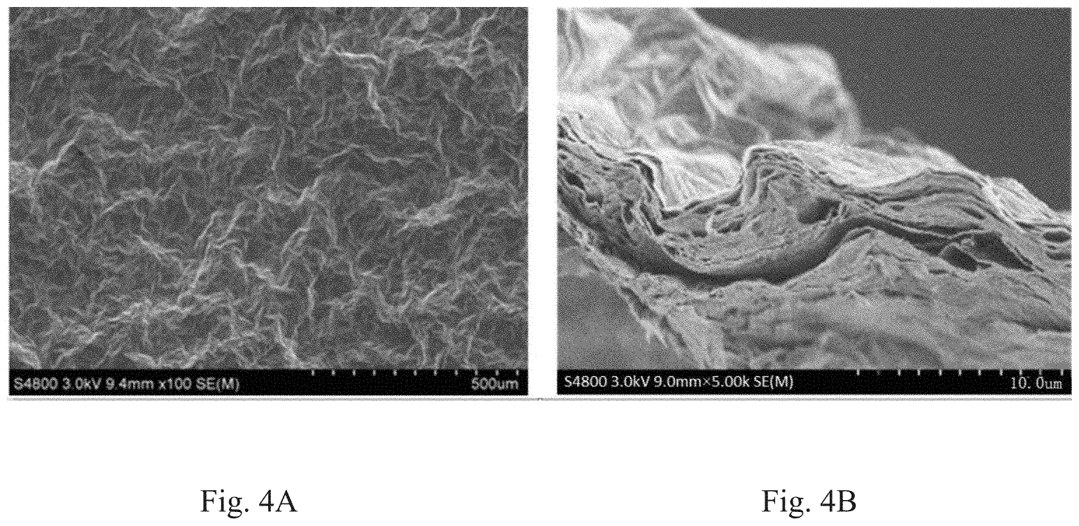

(S3) Dry the graphene oxide gel film obtained by (S2) through hanging in an oven at 70° C. for 10 h, and obtain a flexible graphene oxide film with a crystallinity of 21% and an elongation at break of 35% in a mechanical tensile test, as shown in FIG. 3, no crease is remained after the flexible graphene oxide film is repeatedly folded more than 100,000 times. FIG. 4 is a surface scanning electron micrograph of the graphene oxide film, wherein there are very rich folded structures on the surface of the graphene oxide film, and at the same time, the bending and undulating of the sectional view also shows that the graphene oxide sheets are irregularly stacked. Therefore, it can be known that the graphene oxide film is fully folded from the inside out.

### Third Embodiment

(S1) Perform scraping-film on a graphene oxide solution N-methylpyrrolidone with a concentration of 15 mg/mL by a scraper, and obtain a liquid graphene oxide film with a thickness of 2 mm;

(S2) Immerse the liquid graphene oxide film obtained by (S1) in a poor solvent ethyl acetate for 6 h, and obtain a self-supporting graphene oxide gel film; and

(S3) Dry the graphene oxide gel film obtained by (S2) through hanging in an oven at 80° C. for 15 h, and obtain a flexible graphene oxide film with a crystallinity of 15% and an elongation at break of 40% in a mechanical tensile test, wherein no crease is remained after the flexible graphene oxide film is repeatedly folded more than 100,000 times.

### Fourth Embodiment

(S1) Perform scraping-film on a graphene oxide solution N,N-dimethylacetamide with a concentration of 20 mg/mL by a scraper, and obtain a liquid graphene oxide film with a thickness of 3 mm;

(S2) Immerse the liquid graphene oxide film obtained by (S1) in a poor solvent ethyl acetate for 15 h, and obtain a self-supporting graphene oxide gel film; and

(S3) Dry the graphene oxide gel film obtained by (S2) through hanging in an oven at 90° C. for 10 h, and obtain a flexible graphene oxide film with a crystallinity of 16% and an elongation at break of 50% in a mechanical tensile test, wherein no crease is remained after the flexible graphene oxide film is repeatedly folded more than 100,000 times.

### Fifth Embodiment

(S1) Perform scraping-film on a graphene oxide solution DMF with a concentration of 8 mg/mL by a scraper, and obtain a liquid graphene oxide film with a thickness of 0.5 mm;

(S2) Immerse the liquid graphene oxide film obtained by (S1) in a poor solvent ethyl acetate for 2 h, and obtain a self-supporting graphene oxide gel film; and

(S3) Dry the graphene oxide gel film obtained by (S2) through hanging in an oven at 65° C. for 5 h, and obtain a flexible graphene oxide film with a crystallinity of 14% and an elongation at break of 27% in a mechanical tensile test, wherein no crease is remained after the flexible graphene oxide film is repeatedly folded more than 100,000 times.

### Sixth Embodiment

(S1) Perform scraping-film on a graphene oxide solution pyridine with a concentration of 14 mg/mL by a scraper, and obtain a liquid graphene oxide film with a thickness of 1 mm;

(S2) Immerse the liquid graphene oxide film obtained by (S1) in a poor solvent methanol for 2 h, perform gelation and obtain a graphene oxide gel film; and

(S3) Dry the graphene oxide gel film obtained by (S2) through hanging in an oven at 65° C. for 5 h, and obtain a flexible graphene oxide film with a crystallinity of 59.7% and an elongation at break of 20% in a mechanical tensile test, wherein no crease is remained after the flexible graphene oxide film is repeatedly folded more than 100,000 times.

### Seventh Embodiment

(S1) Perform scraping-film on a graphene oxide solution DMF with a concentration of 8 mg/mL by a scraper, and obtain a liquid graphene oxide film with a thickness of 2 mm;

(S2) Immerse the liquid graphene oxide film obtained by (S1) in a poor solvent ethyl acetate for 6 h, and obtain a self-supporting graphene oxide gel film;

(S3) Dry the graphene oxide gel film obtained by (S2) through hanging in an oven at 70° C. for 10 h, and obtain a flexible graphene oxide film;

(S4) Place the flexible graphene oxide film obtained by (S3) in a hydroiodic acid aqueous solution and then heat at 85° C. for 6 h, perform reduction and obtain a reduced graphene film; and

(S5) Place the reduced graphene film in ethanol at 60° C. for 30 min, wash away residual hydriodic acid in the reduced graphene film, naturally dry, and obtain a flexible graphene film.

Contrast: the liquid graphene oxide film obtained by (S1) is directly dried at 70° C. for 10 h to obtain a graphene oxide film, and then the graphene oxide film is reduced as same as the steps of (S4) and (S5) mentioned above.

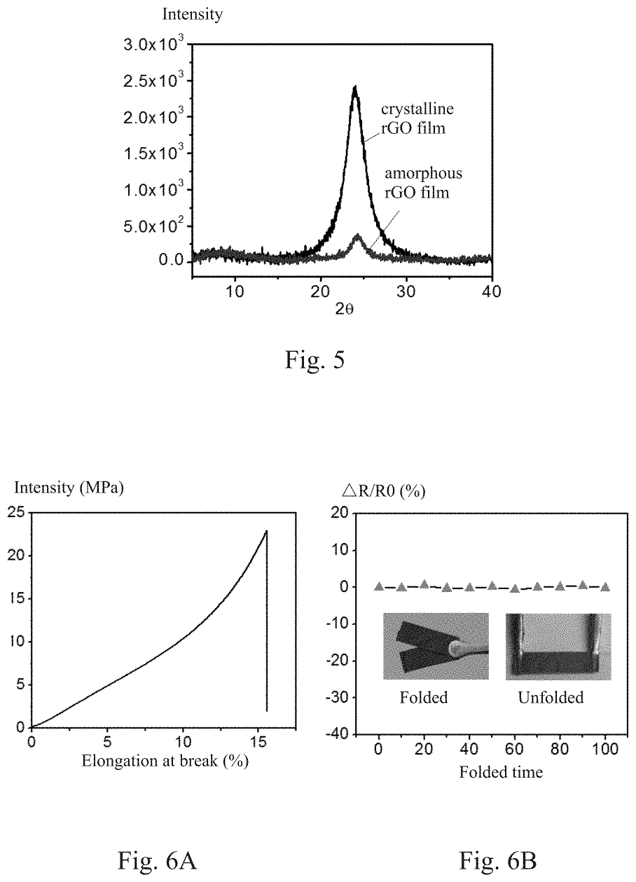

FIG. 5 shows an XRD diffraction comparison chart which is obvious that the graphene film immersed by the poor solvent has low crystallinity. The shrinkage folds of the graphene sheets in the poor solvent and the shrinkage caused by the evaporation of the solvent in the process of drying the gel film both cause the macroscopic shrinkage of the graphene film. The regularly stacked graphene film which is not immersed by the poor solvent has a high crystallization peak, which is similar to the crystalline polymer.

### Eighth Embodiment

(S1) Perform scraping-film on a graphene oxide solution DMF with a concentration of 5 mg/mL by a scraper, and obtain a liquid graphene oxide film with a thickness of 1 mm;

(S2) Immerse the liquid graphene oxide film obtained by (S1) in a poor solvent ethyl acetate for 4 h, and obtain a self-supporting graphene oxide gel film;

(S3) Dry the graphene oxide gel film obtained by (S2) through hanging in an oven at 70° C. for 10 h, and obtain a flexible graphene oxide film;

(S4) Place the flexible graphene oxide film obtained by (S3) in a hydroiodic acid aqueous solution and then heat at 85° C. for 6 h, perform reduction and obtain a reduced graphene film; and

(S5) Place the reduced graphene film in ethanol at 60° C. for 3 h, wash away residual hydriodic acid in the reduced graphene film, naturally dry, and obtain a flexible graphene film, wherein there are very rich folded structures on the surface of the graphene film; and at the same time, the bending and undulating of the sectional view also shows that the graphene sheets are irregularly stacked. Therefore, it can be known that the graphene film is fully folded from the inside out. The film has a crystallinity of 23% and an elongation at break of 18% (as shown in FIG. 6A), and no crease is remained after the flexible graphene film is repeatedly folded more than 100,000 times. The graphene film has little change in electrical resistance during the bending process, as shown in FIG. 6B, and its conductivity is 41,000 s/m.

### Ninth Embodiment

(S1) Perform scraping-film on a graphene oxide solution N-methylpyrrolidone with a concentration of 15 mg/mL by a scraper, and obtain a liquid graphene oxide film with a thickness of 2 mm;

(S2) Immerse the liquid graphene oxide film obtained by (S1) in a poor solvent ethyl acetate for 6 h, and obtain a self-supporting graphene oxide gel film;

(S3) Dry the graphene oxide gel film obtained by (S2) through hanging in an oven at 80° C. for 15 h, and obtain a flexible graphene oxide film;

(S4) Place the flexible graphene oxide film obtained by (S3) in a hydroiodic acid aqueous solution and then heat at 80° C. for 7 h, perform reduction and obtain a reduced graphene film; and

(S5) Place the reduced graphene film in ethanol at 60° C. for 30 min, wash away residual hydriodic acid in the reduced graphene film, naturally dry, and obtain a flexible graphene film with a crystallinity of 17% and an elongation at break of 31%, wherein no crease is remained after the flexible graphene film is repeatedly folded more than 100,000 times. The flexible graphene film has little change in electrical resistance during the bending process, and its conductivity is 35,000 s/m.

### Tenth Embodiment

(S1) Perform scraping-film on a graphene oxide solution N,N-dimethylacetamide with a concentration of 40 mg/mL by a scraper, and obtain a liquid graphene oxide film with a thickness of 30 mm;

(S2) Immerse the liquid graphene oxide film obtained by (S1) in a poor solvent ethyl acetate for 24 h, and obtain a self-supporting graphene oxide gel film;

(S3) Dry the graphene oxide gel film obtained by (S2) through hanging in an oven at 90° C. for 10 h, and obtain a flexible graphene oxide film;

(S4) Place the flexible graphene oxide film obtained by (S3) in a hydroiodic acid aqueous solution and then heat at 85° C. for 8 h, perform reduction and obtain a reduced graphene film; and

(S5) Place the reduced graphene film in ethanol at 60° C. for 30 min, wash away residual hydriodic acid in the reduced graphene film, naturally dry, and obtain a flexible graphene film with a crystallinity of 18% and an elongation at break of 50%, wherein no crease is remained after the flexible graphene film is repeatedly folded more than 100,000 times. The flexible graphene film has little change in electrical resistance during the bending process, and its conductivity is 30,000 s/m.

### Eleventh Embodiment

(S1) Perform scraping-film on a graphene oxide solution DMF with a concentration of 8 mg/mL by a scraper, and obtain a liquid graphene oxide film with a thickness of 0.5 mm;

(S2) Immerse the liquid graphene oxide film obtained by (S1) in a poor solvent ethyl acetate for 1 h, and obtain a self-supporting graphene oxide gel film;

(S3) Dry the graphene oxide gel film obtained by (S2) through hanging in an oven at 65° C. for 5 h, and obtain a flexible graphene oxide film;

(S4) Place the flexible graphene oxide film obtained by (S3) in a hydroiodic acid aqueous solution and then heat at 75° C. for 4 h, perform reduction and obtain a reduced graphene film; and

(S5) Place the reduced graphene film in ethanol at 60° C. for 30 min, wash away residual hydriodic acid in the reduced graphene film, naturally dry, and obtain a flexible graphene film with a crystallinity of 15% and an elongation at break of 26%, wherein no crease is remained after the flexible graphene film is repeatedly folded more than 100,000 times. The flexible graphene film has little change in electrical resistance during the bending process, and its conductivity is 540,000 s/m.

### Twelfth Embodiment

(S1) Perform scraping-film on a graphene oxide solution Pyridine with a concentration of 14 mg/mL by a scraper, and obtain a liquid graphene oxide film with a thickness of 1 mm;

(S2) Immerse the liquid graphene oxide film obtained by (S1) in methanol for 2 h, perform gelation and obtain a self-supporting graphene oxide gel film;

(S3) Dry the graphene oxide gel film through hanging in an oven at 65° C. for 5 h, and obtain a flexible graphene oxide film; and

(S4) Perform electroreduction on the flexible graphene oxide film obtained by (S3), and obtain a flexible graphene film with a crystallinity of 59.7% and an elongation at break of 15%, wherein no crease is remained after the flexible graphene film is repeatedly folded more than 100,000 times.

1. A flexible graphene film, which comprises multiple folded graphene oxide sheets which are lapped with each other, or comprises multiple folded graphene sheets which are lapped with each other, wherein a crystallinity of the flexible graphene film is lower than 60%.

2. A preparation method of a flexible graphene oxide film, which comprises steps of:
(S1) dispersing graphene oxide in a good solvent, obtaining a graphene oxide solution with a concentration in a range of 5-20 mg/mL, performing scraping-film, and obtaining a liquid graphene oxide film;
(S2) immersing the liquid graphene oxide film in a poor solvent for 2 to 24 h, performing gelation, and obtaining a graphene oxide gel film; and
(S3) drying the graphene oxide gel film, and obtaining the flexible graphene oxide film.

3-8. (canceled)

9. The preparation method of the flexible graphene oxide film, as recited in claim 2, wherein: in the step of (S1), the good solvent is at least one member selected from a group consisting of N,N-dimethylformamide, water, N-methylpyrrolidone, acetone, dimethyl sulfoxide, pyridine, dioxane, N,N-dimethylacetamide, tetrahydrofuran and ethylene glycol.

10. The preparation method of the flexible graphene oxide film, as recited in claim 2, wherein: a thickness of the liquid graphene oxide film is in a range of 0.5 to 30 mm, and the scraping-film is performed at a speed in a range of 1 to 20 mm/s.

11. The preparation method of the flexible graphene oxide film, as recited in claim 2, wherein: in the step of (S2), the poor solvent is at least one member selected from a group consisting of ethyl acetate, dichloromethane, alkanes, methanol, ethanol, n-butanol, ethylene glycol, propylene glycol, glycerol, isobutanol, methyl acetate, butyl acetate, and acetic acid.

12. The preparation method of the flexible graphene oxide film, as recited in claim 2, wherein: in the step of (S3), the graphene oxide gel film is dried at 50-100° C. in an oven or is dried by hanging for 5-24 h.

13. A preparation method of a flexible graphene film, which comprises steps of:
(S1) dispersing graphene oxide in a good solvent, obtaining a graphene oxide solution with a concentration in a range of 5-40 mg/mL, performing scraping-film, and obtaining a liquid graphene oxide film;
(S2) immersing the liquid graphene oxide film in a poor solvent for 1 to 24 h, performing gelation, and obtaining a graphene oxide gel film;
(S3) drying the graphene oxide gel film, and obtaining a flexible graphene oxide film; and
(S4) performing reduction on the flexible graphene oxide film, and obtaining the flexible graphene film.

14. The preparation method of the flexible graphene film, as recited in claim 13, wherein: in the step of (S1), the good solvent is at least one member selected from a group consisting of N,N-dimethylformamide, water, N-methylpyrrolidone, acetone, dimethyl sulfoxide, pyridine, dioxane, N,N-dimethylacetamide, tetrahydrofuran and ethylene glycol.

15. The preparation method of the flexible graphene film, as recited in claim 13, wherein: a thickness of the liquid graphene oxide film is in a range of 0.5 to 30 mm, and the scraping-film is performed at a speed in a range of 1 to 20 mm/s.

16. The preparation method of the flexible graphene film, as recited in claim 13, wherein: in the step of (S2), the poor solvent is at least one member selected from a group consisting of ethyl acetate, dichloromethane, alkanes, methanol, ethanol, n-butanol, ethylene glycol, propylene glycol, glycerol, isobutanol, methyl acetate, butyl acetate, and acetic acid.

17. The preparation method of the flexible graphene film, as recited in claim 13, wherein: in the step of (S3), the graphene oxide gel film is dried at 50-100° C. in an oven or is dried by hanging for 5-24 h.

18. The preparation method of the flexible graphene film, as recited in claim 13, wherein: in the step of (S4), the reduction is chemical reduction, thermal reduction, or electroreduction.
